(19) United States
(12) Patent Application Publication
(10) Pub. No.: US 2026/0203794 A1
(43) Pub. Date: Jul. 16, 2026

(54) METHODS AND SYSTEMS FOR GROUP VALUATION AND MANAGEMENT OF VEHICLES

(71) Applicant: Bookoutz, LLC, Greenville, SC (US)

(72) Inventors: Kenneth R. Welch, Greenville, SC (US); Mike Kenefsky, Greenville, SC (US)

(21) Appl. No.: 19/447,768

(22) Filed: Jan. 13, 2026

Related U.S. Application Data
(60) Provisional application No. 63/744,476, filed on Jan. 13, 2025.

(51) Int. Cl. G06Q 30/02; G06Q 30/0202

(52) U.S. Cl. CPC G06Q 30/0278; G06Q 30/0202

(57) ABSTRACT

In one embodiment, a system for vehicle valuation includes a batch processing module configured to receive a plurality of vehicle identifiers corresponding to a plurality of vehicles in a defined inventory group. The system further includes a processor and memory configured to retrieve vehicle information for the plurality of vehicles from external sources utilizing heterogeneous data schemas, normalize disparate condition metrics from the external sources into a common internal representation using normalization logic, perform a conflict resolution operation when multiple external sources provide conflicting values by identifying outliers and aggregating non-outlier values according to source-specific weights, apply condition-based valuation metrics to adjust the estimated values for each vehicle, and generate a valuation report comprising at least the adjusted estimated value of each vehicle and a disposition timing recommendation. The system also includes a user interface configured to present the valuation report.

### CROSS-REFERENCE TO RELATED APPLICATIONS

This application claims priority to U.S. Provisional Application No. 63/744,476, entitled “METHODS AND SYSTEMS FOR GROUP VALUATION AND MANAGEMENT OF VEHICLES,” filed Jan. 13, 2025, which is hereby incorporated by reference in its entirety.

### TECHNICAL FIELD

The field of the subject matter described herein relates generally to methods and systems for valuing and managing vehicles. More specifically, the field relates to methods, devices, and systems for valuing and managing groups of vehicles.

### BACKGROUND

Electronic valuation of vehicle groups presents technical challenges arising from data heterogeneity and synchronization requirements. External data sources, such as wholesale auctions and retail aggregators, utilize disparate data schemas, incompatible condition grading scales (e.g., numerical 1-5 versus categorical “Clean/Average”), and varying update frequencies. These heterogeneities create computational obstacles for systems that aggregate and reconcile vehicle information from multiple sources.

Several interrelated technical problems compound when processing vehicle groups rather than individual vehicles. First, schema heterogeneity requires normalization mechanisms capable of adapting when external sources modify their grading methodologies. Second, retrieving data from multiple external sources introduces latency that can scale unfavorably with the number of sources queried. Third, conflicting data entries from different sources require reconciliation approaches that account for differential source reliability. Addressing these challenges in combination, particularly at fleet scale, needs coordinated architectural solutions.

### SUMMARY

Disclosed within are methods and systems for valuing vehicles and managing vehicle inventory in bulk. In one embodiment, a system for vehicle valuation includes a batch processing module configured to receive a plurality of vehicle identifiers corresponding to a plurality of vehicles in a defined inventory group. The system further includes a processor and memory configured to retrieve vehicle information for the plurality of vehicles from external sources utilizing heterogeneous data schemas, normalize disparate condition metrics from the external sources into a common internal representation (such as a unified grading scale) using normalization logic, perform a conflict resolution operation when multiple external sources provide conflicting values for a same vehicle by identifying outliers according to a statistical dispersion measure and aggregating non-outlier values according to source-specific weights derived from source reliability indicators, apply condition-based valuation metrics using the common internal representation to adjust the estimated values for each vehicle in the defined inventory group, and generate a valuation report comprising at least the adjusted estimated value of each vehicle in the defined inventory group and a disposition timing recommendation for at least one vehicle based on projected values and market trends. The system also includes a user interface configured to present the valuation report.

The features and advantages described in this summary and the following detailed description are not all-inclusive. Many additional features and advantages will be apparent to one of ordinary skill in the art in view of the drawings, specification, and claims presented herein.

### BRIEF DESCRIPTION OF THE DRAWINGS

The present embodiments are illustrated by way of example and are not intended to be limited by the figures of the accompanying drawings. In the drawings:

FIG. 1 is a functional block diagram illustrating an exemplary system for valuing and managing groups of vehicles in accordance with embodiments of the present disclosure.

FIG. 2 is a flow chart illustrating an exemplary method for valuing and managing groups of vehicles in accordance with embodiments of the present disclosure.

FIG. 3 is a block diagram illustrating normalization logic and data transformation within the vehicle valuation system in accordance with embodiments of the present disclosure.

FIG. 4 is a sequence diagram illustrating an asynchronous batch retrieval process for vehicle information from multiple external data sources in accordance with embodiments of the present disclosure.

FIG. 5 is a valuation vector data flow diagram illustrating the calculation of a final adjusted value for a vehicle in accordance with embodiments of the present disclosure.

### DETAILED DESCRIPTION

The system described herein addresses the technical challenges of data heterogeneity, retrieval latency, and conflict resolution that arise when processing vehicle groups. To address data heterogeneity arising from heterogeneous data schemas and disparate condition grading schemas used by different external sources, the system employs normalization logic. To address retrieval latency that can accumulate when retrieving data from multiple external sources, the system implements asynchronous API polling using non-blocking requests that transmit concurrent request signals to multiple external sources simultaneously, reducing total retrieval time from a linear function of the number of sources to a constant bounded by the slowest responding source. To address unreliable conflict resolution when external sources provide conflicting data, the system performs a conflict resolution operation that identifies outliers according to a statistical dispersion measure and applies a weighted averaging algorithm based on source reliability indicators including historical accuracy, data freshness, and source specificity factors.

The system enables users to create profiles containing vehicle inventory information, either through manual entry or bulk upload via API integration with asset tracking systems. Each vehicle entry includes identifying information such as VIN, make, model, year, and condition indicators. The following sections describe the technical architecture for batch processing and valuation of the vehicles within a user's defined inventory groups with reference to the accompanying figures.

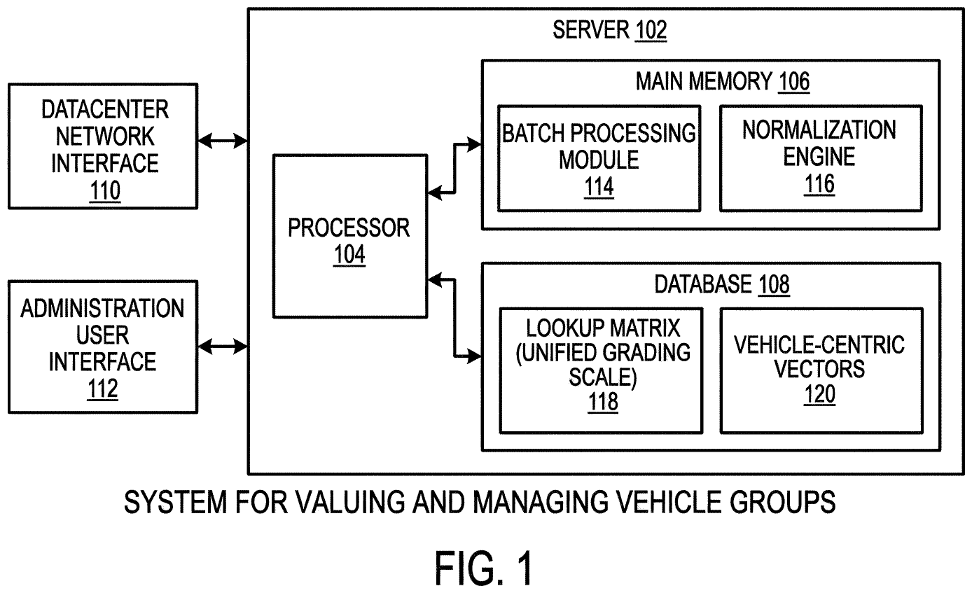

FIG. 1 is a block diagram illustrating a system 100 for valuing and managing vehicle groups in accordance with embodiments of the present disclosure. The system 100 includes a server 102 that contains several interconnected components for processing vehicle information and generating valuation reports. The server 102 may be configured to host a server 102 operating system and, in some embodiments, may be distributed over a plurality of hardware servers using hypervisor technology.

The server 102 includes a processor 104 that serves as the central processing element and communicates with other components of the system. The processor 104 may be a multi-core server 102 class processor 104 suitable for hardware virtualization. The processor 104 may support at least a 64-bit architecture and a single instruction multiple data (SIMD) instruction set. The processor 104 executes batch processing operations, performs normalization of condition metrics, and generates valuation reports for defined inventory groups.

The processor 104 is connected to a main memory 106, which may include a combination of volatile memory (e.g., random access memory) and non-volatile memory (e.g., flash memory). The main memory 106 contains a batch processing module 114 and a normalization engine 116. The batch processing module 114 is configured to receive a plurality of vehicle identifiers corresponding to a defined inventory group and to coordinate the retrieval and processing of vehicle information for the vehicles in the defined inventory group. The normalization engine 116 implements normalization logic that maps incoming condition grades from external sources to a common internal representation such as a unified grading scale, enabling consistent comparison and aggregation of condition data across all vehicles in a defined inventory group.

The processor 104 is also connected to a database 108, which may include one or more hard drives for persistent storage. The database 108 stores a lookup matrix 118 and vehicle-centric vectors 120. The lookup matrix 118 contains a unified grading scale that defines equivalence thresholds for each external source, allowing the normalization engine 116 to convert disparate condition metrics into standardized values. The vehicle-centric vectors 120 store vehicle-specific data used for predictive pricing and valuation calculations. The machine learning models utilized for predictive pricing are trained on historical transaction data featuring the vehicle-centric vectors 120. Feature engineering involves extracting temporal features (e.g., ‘convertible in winter’ for seasonal demand), geographic economic indicators (e.g., regional fuel prices), and model-specific depreciation curves. The system may employ a gradient-boosted decision tree architecture to handle non-linear interactions between vehicle condition (categorical) and mileage (numerical), or ensemble methods combining trees with neural networks to output a predicted future value curve for each vehicle in the group.

The processor 104 is further connected to a datacenter network interface 110, which provides one or more high-speed communication ports to data center switches, routers, and network storage appliances. The datacenter network interface 110 may include high-speed optical Ethernet, InfiniBand (IB), Internet Small Computer System Interface (iSCSI), and/or Fibre Channel interfaces. The datacenter network interface 110 enables the system to connect to external data sources such as wholesale platforms, trade-in programs, new vehicle retail sites, and third-party vehicle evaluation services.

The processor 104 is additionally connected to an administration user interface 112, which supports local and remote configuration of the server 102 by an administrator. The administration user interface 112 allows users to add vehicles, view valuation details, and monitor fleet performance. The administration user interface 112 may be designed to provide a straightforward and intuitive experience, and may include dashboards, charts, and reports that present data in a clear and actionable format. To ensure data security, the system may incorporate secure login protocols and encryption mechanisms to protect user information, including personal data and vehicle inventory details, from unauthorized access.

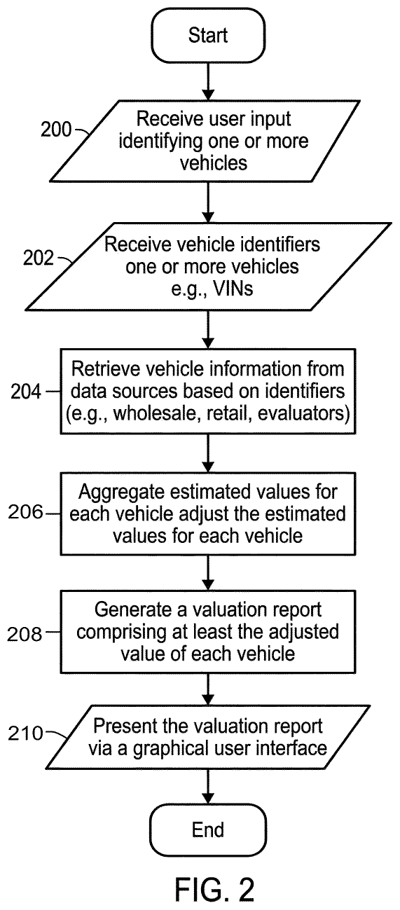

FIG. 2 is a flow chart illustrating an exemplary method for valuing and managing groups of vehicles in accordance with embodiments of the present disclosure. The method may include a computer-implemented method comprising instructions stored on a non-transitory computer-readable storage medium and executed on a computing device provided with a hardware processor 104 and a memory.

At step 200, the method includes receiving user input identifying one or more vehicles. For example, the user may type the make, model, and year of a vehicle into a text field. This input could come from a predefined list, where users select vehicles by clicking checkboxes. In other cases, the user might upload vehicle details in bulk using a CSV file. The system may also guide the user with prompts or autocomplete suggestions to ensure accurate data entry.

At step 202, the method includes receiving, via the batch processing module 114, a plurality of vehicle identifiers corresponding to a defined inventory group. For example, the user may input the VIN (Vehicle Identification Number) for each vehicle in the defined inventory group. The identifier could also be derived from other data provided by the user, such as a license plate number. Additionally, integration with third-party databases may automatically fetch identifiers once basic details are entered. The batch processing module 114 enables the system to process multiple vehicles simultaneously as part of the defined inventory group, ensuring efficient handling of fleet-scale valuations.

At step 204, the method includes retrieving vehicle information for the plurality of vehicles from external sources such as wholesale platforms, trade-in programs, new vehicle retail pricing, and third-party vehicle evaluators, based on the vehicle identifiers. The external sources may utilize heterogeneous data schemas including different data formats, incompatible condition grading scales, and varying update frequencies. The method further includes normalizing disparate condition metrics from the external sources into a common internal representation using normalization logic. For example, the system might connect to a wholesale platform to determine the latest auction price trends for similar vehicles. Data from trade-in programs can also provide benchmarks specific to vehicles in a particular geographic area. Because different external sources may utilize incompatible condition grading scales, such as numerical grades versus categorical grades, the system maps these disparate metrics to an internal unified scale, enabling consistent comparison and aggregation of condition data across all vehicles in the defined inventory group.

In one embodiment, the vehicle information retrieved from the external sources is periodically updated. For example, the system might schedule updates at regular intervals, such as daily or weekly, to ensure accuracy. These updates could pull in changes to wholesale pricing, trade-in offers, or retail listings. By incorporating real-time data, the system can reflect fluctuations in the market or seasonal trends. Additionally, periodic updates help maintain relevance when the same vehicles are evaluated multiple times over a period.

In one embodiment, determining a market value range for each vehicle by calculating the average, lowest, and highest prices for the vehicle based on condition, region, and market trends. For example, the system might analyze historical sales data to establish the range for each vehicle. It could adjust these calculations based on regional factors, such as higher demand in urban areas or lower prices in rural markets. The condition of the vehicle, including mileage and cosmetic factors, might heavily influence the range. Trends such as new model releases or fuel price changes can also play a role in determining market value ranges.

At step 206, the method includes aggregating estimated values for each vehicle in the defined inventory group from the external sources and applying condition-based valuation metrics using the common internal representation to adjust the estimated values for each vehicle in the defined inventory group. When multiple external sources provide conflicting values for a same vehicle, the system performs a conflict resolution operation comprising identifying outliers according to a statistical dispersion measure and aggregating non-outlier values according to source-specific weights derived from source reliability indicators. For example, the system might calculate a weighted average of values from all external sources to provide a more balanced estimate. It could also exclude or down weight values that deviate from others, considering them potential outliers. The system then applies condition-based adjustments, where a vehicle with lower mileage than average might have its value adjusted upwards. The system could also account for other condition factors such as recent repairs, cosmetic damage, or missing components. By utilizing the common internal representation, the adjustments ensure consistent and accurate valuations across all vehicles in the defined inventory group.

In one embodiment, the condition and corresponding valuation of each vehicle may be adjusted to track repairs and upgrades for each vehicle. For example, the system might increase the valuation of a vehicle if the user records a major repair, such as engine replacement or bodywork. Repairs that address issues, like brake or suspension fixes, could also result in upward adjustments. Conversely, the system could maintain a record of incomplete repairs or deferred maintenance that might lower the valuation. Upgrades, such as installing premium features or performance enhancements, may also positively influence the vehicle's market value.

In one embodiment, users can add vehicles and view valuation details. For example, a user might enter a vehicle by providing basic details such as make, model, year, and VIN. Once added, the system could immediately retrieve relevant data and display the vehicle's current valuation. Users may also see additional details, such as market value ranges and condition-based adjustments, to better understand the assessment. The interface could allow users to manage multiple vehicles in a personal dashboard for easier tracking and comparison.

At step 208, the method includes generating a valuation report comprising at least the adjusted value of each vehicle and a disposition timing recommendation for at least one vehicle based on projected values and market trends. For example, the report might include a summary table showing the adjusted values alongside the unadjusted estimates for transparency. It may also highlight factors that influenced the adjustments, such as mileage or recent market trends. The disposition timing recommendation may indicate whether to sell, hold, or acquire each vehicle based on comparing current adjusted estimated values against projected future values. The report could include visual elements like graphs or charts to make the information easier to interpret. A detailed breakdown provides users with actionable insights for making informed decisions.

In one embodiment, a platform that offers a highest value for each vehicle may be identified. For example, the system might analyze data from multiple platforms, such as trade-in programs, retail channels, and wholesale auctions, to find the best offer. The identified platform could vary based on the vehicle's type and condition, with some platforms specializing in certain makes or models. This information could be presented to users alongside recommendations for maximizing their returns. The system ensures users have access to competitive pricing by leveraging diverse market sources.

In one embodiment, an aggregate value of all vehicles input by the user may be provided. For example, the system might sum the adjusted values of all user-added vehicles to provide a total portfolio valuation. This feature could be particularly useful for fleet managers or dealers managing multiple vehicles. The aggregated value might also include breakdowns by category, such as retail vs. trade-in valuations. Users could leverage this information to evaluate the overall worth of their inventory and plan accordingly.

In one embodiment, pricing trends and factors like seasonal demand or geographic variations in pricing may be predicted using a machine learning model. For example, the system might analyze historical data to identify trends, such as higher demand for SUVs in winter or sports cars in summer. Geographic variations might show that vehicles fetch higher prices in urban markets compared to rural areas. The machine learning model could also consider macroeconomic factors, like changes in fuel prices or interest rates, that affect market dynamics. By incorporating these insights, the system can provide users with forward-looking predictions for better decision-making.

In one embodiment, market insights comprising pricing trends for each vehicle may be determined and presented to the user. For example, users might see graphs showing the historical price trajectory of a specific vehicle over the past year. The system could highlight trends such as a vehicle's depreciation rate or sudden price spikes due to market shifts. These insights may include comparisons with similar vehicles in the same category or region. Users can utilize this information to better understand the factors influencing their vehicle's value.

In one embodiment, optimal times to sell each vehicle may be suggested based on at least one of market demand, the season, or price trends. For example, the system might recommend selling a convertible in spring when demand typically peaks. It could also suggest delaying the sale of a family sedan until back-to-school season when demand increases. Recommendations might incorporate real-time market data to ensure users act on the current trends. This feature helps users maximize returns by aligning their sale timing with favorable market conditions.

In some embodiments, the valuation report may include disposition timing recommendations for vehicles in the defined inventory group. The disposition timing recommendations may indicate whether to sell, hold, or acquire each vehicle based on projected values and market trends. The system may generate the disposition timing recommendations by comparing current adjusted estimated values against projected future values derived from the predictive model, identifying vehicles where projected depreciation exceeds a threshold rate, and flagging such vehicles as candidates for near-term disposition. The system may also identify vehicles where projected values indicate appreciation or stable value retention, recommending that such vehicles be held. The disposition timing recommendations may account for seasonal demand patterns, geographic market variations, and vehicle-specific factors such as approaching mileage thresholds or model year transitions.

In some embodiments, the disposition timing recommendations may include acquire indicators that recommend acquiring additional vehicles. The system may generate acquire indicators by analyzing market data to identify vehicles that are undervalued relative to their projected future values, such as vehicles where current market prices fall below the predicted value trajectory by more than a configurable threshold percentage. The system may also identify acquisition opportunities based on inventory composition analysis, where the system evaluates the user's current defined inventory group and identifies vehicle types or categories that are underrepresented relative to market demand patterns. For example, if market trend analysis indicates increasing demand for a particular vehicle segment and the user's inventory has limited representation in that segment, the system may generate an acquire indicator for vehicles in that segment. Additionally, the system may factor in seasonal timing, recommending acquisition of certain vehicle types during periods of historically lower prices, such as recommending acquisition of convertibles during winter months when demand and prices are typically reduced. The acquire indicators may be presented in the valuation report alongside sell and hold indicators, providing users with a comprehensive view of recommended actions for optimizing their vehicle portfolio.

At step 210, the method includes presenting the valuation report via a graphical user interface. For example, the interface might display the report in a tabular format, allowing the user to sort by columns like adjusted value or vehicle identifier. Interactive elements like filters or dropdowns could enable users to view specific sections of the report. The system may also include a download option to export the report in formats such as PDF or Excel. Notifications might alert the user to notable findings, such as vehicles with unusually high or low valuations.

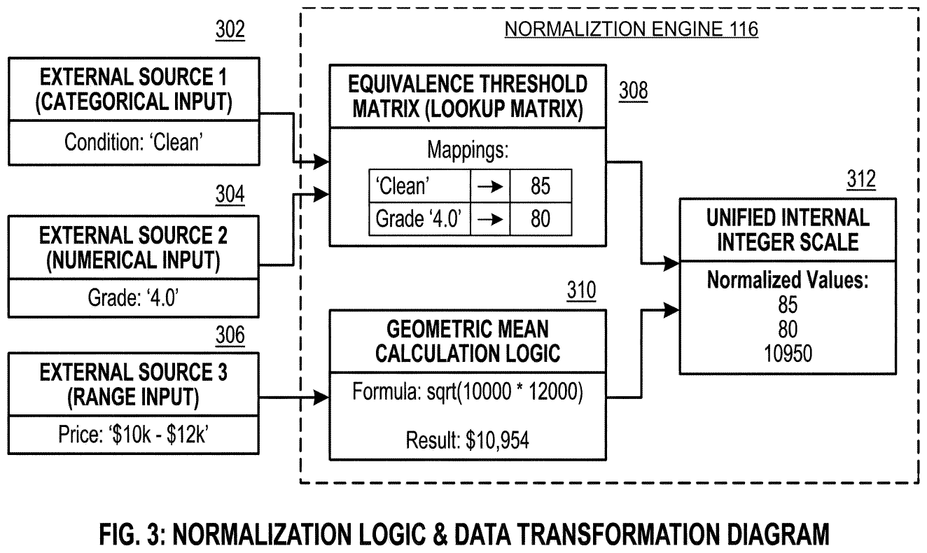

To address data heterogeneity when processing vehicle groups, the system may employ a normalization engine 116 that maps incoming condition grades from external sources to a unified grading scale, as described in detail with reference to FIG. 3.

FIG. 3 is a block diagram illustrating normalization engine 116 and data transformation within the vehicle valuation system in accordance with embodiments of the present disclosure. The normalization engine 116 receives disparate condition grades from external sources 302, 304, 306 and transforms them into a unified grading scale 312, enabling consistent comparison and aggregation of condition data across all vehicles in a defined inventory group. The primary components depicted in FIG. 3 include the normalization engine 116, which serves as the central processing element, an external categorical input 302 representing non-numerical condition grades such as “Clean” or “Average,” an external numerical input 304 representing numerical grades or range-based values such as “4.0” on a 5.0 scale, an external range input 306 representing or a price range of “$10 k-$12 k,” an equivalence threshold matrix 308 that stores mappings between external grading schemas and internal values, a geometric mean calculation logic 310, and the unified grading scale 312 that provides a standardized output format for all normalized condition metrics.

When the normalization engine 116 receives an external categorical input 302, such as a condition grade of “Clean” from a first external source, the normalization engine 116 queries the equivalence threshold matrix 308 to determine the corresponding value on the unified grading scale 312. The equivalence threshold matrix 308 functions as a lookup matrix containing predefined mappings that associate categorical condition descriptors with specific integer values. For example, the equivalence threshold matrix 308 may define that a categorical grade of “Clean” corresponds to a value of 85 on the unified grading scale 312, while a categorical grade of “Average” corresponds to a value of 70, and a categorical grade of “Rough” corresponds to a value of 50. The normalization engine 116 retrieves the appropriate mapping from the equivalence threshold matrix 308 and outputs the corresponding integer value to the unified grading scale 312. This categorical mapping process enables the system to convert qualitative condition assessments from various external sources 302, 304, 306 into quantitative values suitable for mathematical aggregation and comparison across all vehicles in the defined inventory group.

In various embodiments, the normalization logic may be implemented using different mapping structures and transformation approaches. The mapping structure may comprise a lookup matrix such as the equivalence threshold matrix 308 or a learned mapping model trained to convert external grading schemas into internal normalized values. The learned mapping model may be trained on historical data correlating external source outputs with actual transaction outcomes, enabling the model to adaptively map new or modified external schemas without manual reconfiguration. In some cases, the normalization logic may employ arithmetic mean calculation, geometric mean calculation, median calculation, or other central tendency measures when converting range-based inputs to single normalized values. The common internal representation may comprise a numerical scale, a categorical classification, a vector representation, or other data structure suitable for consistent comparison and aggregation across vehicles in the defined inventory group.

When the normalization engine 116 receives an external numerical input 304, the transformation process may involve scale conversion or geometric mean calculation depending on the input format. For numerical grades expressed on different scales, the normalization engine 116 applies a proportional mapping to convert the external value to the unified grading scale 312. For example, if a second external source provides a numerical grade of “4.0” on a 5.0-point scale, the normalization engine 116 calculates the equivalent value on the 100-point unified grading scale 312 by computing (4.0/5.0)×100=80. For range-based inputs 306, such as a price range of “$10 k-$12 k,” the normalization engine 116 may employ geometric mean calculation logic 310 to derive a single normalized value from the range limits. The geometric mean calculation logic 310 computes the geometric mean as the square root of the product of the range limits, yielding sqrt(10,000×12,000)=$10,954 as the normalized value. This approach may be preferred over arithmetic mean calculation because the geometric mean provides a value that better represents the central tendency of multiplicative or ratio-based data, which is common in pricing contexts. The equivalence threshold matrix 308 may also store conversion factors and scale definitions for each known external source, enabling the normalization engine 116 to automatically apply the appropriate transformation based on the source identifier associated with each incoming data element. By normalizing all external inputs to the unified grading scale 312, the system ensures that subsequent valuation calculations operate on consistent, comparable data regardless of the original format or grading schema used by each external source.

In some embodiments, when multiple external sources 302, 304, 306 provide conflicting condition metrics or estimated values for the same vehicle, the system may employ a weighted averaging algorithm based on source reliability to resolve discrepancies. Each external data source may be assigned a reliability score that reflects factors such as historical accuracy, data freshness, and source specificity. Historical accuracy may be determined by comparing past valuations from a source against actual transaction prices, with sources demonstrating closer alignment receiving higher reliability scores. Data freshness may account for how recently the source updated its information, with more current data weighted more heavily. Source specificity may consider whether a source specializes in particular vehicle types, makes, or geographic regions, with specialized sources receiving higher weights for vehicles within their domain of expertise.

When conflicting values are received, the system may calculate a weighted average where each source's contribution is proportional to its source reliability score. For example, if three sources provide condition grades of 75, 80, and 85 on the unified scale with reliability scores of 0.3, 0.5, and 0.2 respectively, the system may compute the normalized value as (75×0.3+80×0.5+85×0.2)/ (0.3+0.5+0.2)=79.5. The reliability scores may be periodically recalibrated based on ongoing performance metrics, ensuring that the weighting reflects current source quality. This conflict resolution mechanism may enable the system to produce a single normalized value that appropriately balances inputs from multiple sources while accounting for their relative trustworthiness.

The system computes a composite reliability score for each external source by combining the three reliability factors using a weighted formula: R_{composite}=(w₁×R_{accuracy})+(w₂×R_{freshness})+(w₃×R_{specificity}), where R_{accuracy}, R_{freshness}, and R_{specificity} represent the individual factor scores, and w₁, w₂, and w₃ represent configurable weights that sum to 1.0. For example, a configuration prioritizing historical accuracy assigns weights of w₁=0.5, w₂=0.3, and w₃=0.2. Each individual factor score and the composite reliability score are normalized to a scale of 0.0 to 1.0, where scores in the range of 0.0 to 0.3 indicate low reliability, scores in the range of 0.31 to 0.6 indicate medium reliability, and scores in the range of 0.61 to 1.0 indicate high reliability.

The system maintains a reliability profile data structure for each external source, which stores the source identifier, the individual component scores (R_{accuracy}, R_{freshness}, R_{specificity}), the computed composite score R_{composite}, a timestamp indicating when the profile was last updated, and a historical log of past composite scores for trend analysis. For example, a reliability profile for a wholesale auction platform stores R_{accuracy}=0.85, R_{freshness}=0.70, and R_{specificity}=0.60, yielding a composite score of R_{composite}=(0.5×0.85)+(0.3×0.70)+(0.2×0.60)=0.755, which falls within the high reliability range. The reliability profile data structures are stored in the database 108 and are retrieved during conflict resolution to determine the appropriate weighting for each source's contribution to the weighted average calculation.

The following embodiments describe alternative or supplemental approaches to conflict resolution that may be employed individually or in combination with the weighted averaging algorithm described above.

In some embodiments, the system maintains a source-vehicle-affinity matrix that stores reliability scores on a per-source-per-vehicle-type basis rather than as uniform values across all vehicles. The source-vehicle-affinity matrix is a two-dimensional data structure indexed by source identifier and vehicle type category, where each cell contains a reliability score specific to that source-vehicle-type combination. For example, a wholesale auction source may have a reliability score of 0.85 for commercial trucks but a reliability score of 0.60 for luxury sedans, reflecting that source's domain expertise in commercial vehicle valuation. Conversely, a retail aggregator source may have a reliability score of 0.55 for commercial trucks but a reliability score of 0.80 for luxury sedans.

The system populates the source-vehicle-affinity matrix through historical outcome analysis. For each source-vehicle-type combination, the system compares past valuations from the source against actual transaction prices for vehicles within the vehicle type category, computes accuracy metrics based on the comparison, and stores the computed accuracy as the reliability score in the corresponding matrix cell. The system may periodically recalculate these scores as additional transaction data becomes available. During conflict resolution, when the system receives conflicting estimated values from multiple external sources for a vehicle, the system retrieves the vehicle type category for the vehicle being valued, queries the source-vehicle-affinity matrix to obtain the source-specific reliability score for that vehicle type, and applies the retrieved score as the weighting factor in the weighted averaging calculation described above. This source-vehicle-affinity approach enables the system to leverage the domain-specific expertise of different sources, recognizing that sources specializing in particular vehicle segments provide more reliable valuations within their areas of expertise.

In some embodiments, the system implements a multi-stage conflict resolution process that performs outlier detection prior to weighted averaging. In the first stage, the system computes the interquartile range (IQR) of the estimated values received from the external sources for a given vehicle, where the IQR is calculated as the difference between the 75th percentile value and the 25th percentile value of the received estimates. The system defines a dynamic threshold as 1.5 times the IQR. The system flags any source whose estimated value falls below the 25th percentile minus the dynamic threshold, or above the 75th percentile plus the dynamic threshold, as a statistical outlier. In the second stage, the system excludes flagged outlier sources from the weighted averaging calculation, applying the weighted averaging algorithm only to the remaining non-outlier sources.

In the third stage, the system evaluates historical outlier patterns and applies reliability score degradation to sources that are repeatedly flagged as outliers. The system maintains an outlier tracking data structure associated with each source identifier that logs each outlier flagging event with a corresponding timestamp. When a source accumulates outlier flags exceeding a predetermined threshold count within a rolling time window, the system reduces that source's composite reliability score R_{composite} by a degradation factor. For example, the system may apply a degradation factor of 0.05 per excess flag, such that a source exceeding the threshold by three flags experiences a reliability score reduction of 0.15. This multi-stage approach creates a self-correcting mechanism where sources providing consistently anomalous values experience progressive reliability degradation, reducing their influence on future valuations while preserving the influence of sources that provide estimates consistent with market consensus. This multi-stage conflict resolution process produces normalized values with reduced error compared to single-stage weighted averaging because the pre-filtering step removes anomalous data points that would otherwise skew the weighted average, while the reliability degradation mechanism adaptively reduces the influence of sources that repeatedly provide out-of-consensus valuations.

In various embodiments, the conflict resolution operation may employ different approaches for detecting anomalous values and aggregating remaining values. The statistical dispersion measure used for outlier detection may comprise interquartile range analysis as described above, standard deviation thresholds, median absolute deviation, or other robust statistical measures. The source reliability indicators used for weighting may comprise historical accuracy metrics, data freshness indicators, source specificity factors, data completeness scores, or combinations thereof. In some embodiments, the conflict resolution operation may apply fixed source priority rules where certain sources are favored over others based on predetermined rankings. In other embodiments, the conflict resolution operation may employ dynamic reliability scoring that adjusts weights based on ongoing performance metrics. The aggregation of non-outlier values may comprise weighted averaging, weighted median calculation, or other combination methods that account for differential source quality.

In some embodiments, the source reliability indicators may include a data completeness score that quantifies the extent to which an external source provides all expected data fields for a vehicle. The system may define a set of expected data fields for each vehicle type, such as condition grade, mileage, pricing estimate, transaction date, geographic region, and vehicle history indicators. For each response received from an external source, the system may count the number of expected fields that are populated with valid, non-null values and divide by the total number of expected fields to compute a data completeness ratio. For example, if an external source provides values for 8 out of 10 expected fields, the data completeness score for that response is 0.8. The system may maintain a rolling average of data completeness scores for each external source over a configurable time window, such as the most recent 30 days of responses. This rolling average data completeness score may be incorporated into the composite reliability score calculation as an additional factor, such that sources that consistently provide incomplete data receive lower weighting during conflict resolution operations. In some cases, the system may apply a minimum data completeness threshold below which a source's response is excluded from the weighted averaging calculation entirely, ensuring that severely incomplete data does not influence the final normalized value.

In some embodiments, the system implements a market volatility-adjusted freshness scoring mechanism where the freshness component of source reliability degrades at a rate determined by the market volatility for the specific vehicle segment being valued. The system defines vehicle segments based on combinations of vehicle attributes including make, model family, body type, and model year range, grouping vehicles with similar market behavior characteristics into common segments. For each vehicle segment, the system computes a market volatility index by analyzing the standard deviation of price changes observed across transactions within that segment over a rolling time window. The system normalizes the standard deviation by the mean transaction price to produce a coefficient of variation, which serves as the market volatility index. Vehicle segments exhibiting high coefficients of variation, such as segments affected by new model releases, supply chain disruptions, or rapid demand shifts, receive high market volatility index values, while stable segments with consistent pricing receive low market volatility index values.

The system applies the market volatility index as a multiplier to the time-based freshness degradation rate when computing the freshness component R_{freshness} of the composite reliability score described above. For a vehicle in a high-volatility segment with a market volatility index of 2.0, data that is two weeks old experiences freshness degradation equivalent to four weeks of aging in a baseline segment. Conversely, for a vehicle in a low-volatility segment with a market volatility index of 0.5, data that is one month old experiences freshness degradation equivalent to only two weeks of aging in a baseline segment. This volatility-adjusted approach ensures that the system appropriately penalizes stale data in rapidly changing markets while preserving the utility of older data in stable market segments, thereby improving valuation accuracy across varying market conditions.

In some embodiments, the system may employ a request queue that holds pending vehicle identifier queries, allowing the system to manage and prioritize incoming requests for vehicle information retrieval. A thread pool or worker pool may process multiple requests concurrently, with each worker independently handling API calls to different external 302 sources or for different vehicles within the defined inventory group. Callback handlers may aggregate responses as they arrive from the external 302 sources, assembling the retrieved vehicle information into a unified data structure without blocking other pending requests.

The system may further implement error handling logic for managing timeouts, rate limits, and partial failures during batch processing. For example, the system may employ retry mechanisms with exponential backoff when an external source fails to respond within a specified timeout period or returns a rate limit error, progressively increasing the delay between retry attempts to avoid overwhelming the external source. In cases where an external source remains unavailable after a predetermined number of retry attempts, the system may fall back to cached data from previous successful retrievals for that source, ensuring that valuations can still be generated even when some external 302 sources are temporarily inaccessible. Web scraping tools may be employed to extract data from websites by navigating pages programmatically, parsing HTML content, and extracting the information while adhering to legal and ethical standards.

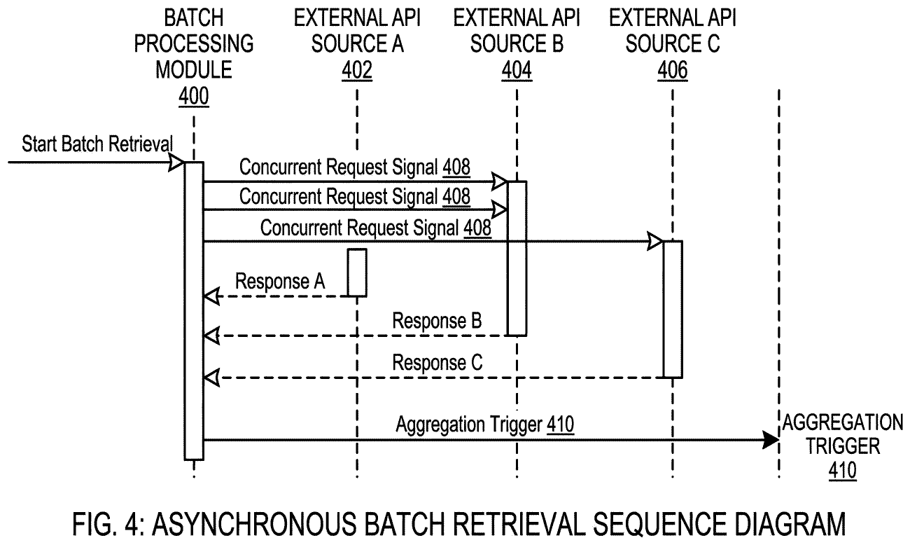

FIG. 4 is a sequence diagram illustrating an asynchronous batch retrieval process for vehicle information from multiple external data sources in accordance with embodiments of the present disclosure. The sequence diagram depicts the interactions between a batch processing module 400 and a plurality of external API sources, including external API source A 402, external API source B 404, and external API source C 406. The external API sources 402, 404, 406 may represent various data providers such as wholesale platforms, retail sites, and trade-in programs that supply vehicle information including pricing data, condition metrics, and market trends.

The batch processing module 400 initiates the retrieval process upon receiving a start batch retrieval signal containing a plurality of vehicle identifiers corresponding to a defined inventory group. In response to this signal, the batch processing module 400 transmits concurrent request signals 408 to each of the external API sources 402, 404, 406 simultaneously rather than sequentially. This concurrent transmission architecture represents a technical improvement over serial processing approaches, as it enables the system to initiate data retrieval from all external sources 302, 304, 306 at substantially the same time, thereby reducing overall latency during group valuations. In a serial processing approach, the system would need to wait for each external source to respond before initiating a request to the next source, resulting in cumulative delays that scale linearly with the number of external sources 302, 304, 306. By contrast, the asynchronous API polling approach implemented through concurrent request signals 408 allows the total retrieval time to be bounded by the slowest responding external source rather than the sum of all response times.

This architectural improvement reduces total retrieval latency from O(n) to O(1) relative to the number of external sources, where n represents the number of external API sources queried. For a system querying five external sources with average response times of two seconds each, the asynchronous architecture reduces worst-case retrieval time from ten seconds to approximately two seconds, representing an 80% reduction in latency for batch processing operations.

Each concurrent request signal 408 may include the vehicle identifiers for the vehicles in the defined inventory group along with parameters specifying the type of information requested from each external API source 402, 404, 406. The external API sources 402, 404, 406 process the requests independently and return responses asynchronously to the batch processing module 400. Because the responses arrive at different times based on network conditions, server 102 load, and processing requirements at each external source, the batch processing module 400 may employ callback handlers or event-driven mechanisms to receive and temporarily store each response as it arrives without blocking other pending requests.

Once the batch processing module 400 has received responses from all external API sources 402, 404, 406, or upon expiration of a predetermined timeout period, an aggregation trigger 410 is generated. The aggregation trigger 410 signals that the vehicle information retrieval phase has completed and initiates subsequent processing steps, such as normalization of disparate condition metrics and aggregation of estimated values for each vehicle in the defined inventory group. In embodiments where one or more external API sources fail to respond within the timeout period, the aggregation trigger 410 may still be generated to allow processing to continue with the available data, and the system may employ fallback mechanisms such as cached data from previous successful retrievals for the non-responsive sources. This asynchronous architecture enables efficient batch processing of vehicle groups by coordinating concurrent API calls to multiple external sources 302, 304, 306 while maintaining system responsiveness and minimizing the time required to generate comprehensive valuation reports.

Once data is retrieved, it is aggregated and cross-referenced within the system. Aggregation involves combining data from multiple sources to create a comprehensive dataset for each vehicle. Cross-referencing ensures consistency and reliability by comparing information from different platforms and resolving discrepancies. For example, pricing data for a vehicle model may vary across regions or platforms, and the system evaluates these variations to establish an accurate range of values.

Dynamic valuations are then performed using computational models, which may include machine learning algorithms. These models process the aggregated data to calculate metrics such as the average market value, the highest and lowest observed prices, and platform-specific valuations. Machine learning models may also predict pricing trends by analyzing historical data, regional variations, and seasonal demand patterns. For instance, a regression model might predict how the value of a particular vehicle model changes over time based on mileage, condition, and geographic location.

Condition-based valuation metrics are applied as adjustments to the valuations by incorporating user-provided inputs, such as wear and tear, mileage, or specific upgrades. These adjustments refine the calculated value to reflect the attributes of the vehicle. The system may use predefined rules or learned parameters to modify the baseline valuation accordingly.

In some embodiments, condition-based adjustments may be calculated using a weighted vector approach. The system may apply a base depreciation curve specific to the vehicle model, which accounts for typical value decline over time and usage. User-provided metrics, such as mileage and damage indicators, may be converted into penalty coefficients that quantify the impact of each condition factor. The final adjusted value 518 may be calculated using the formula: V_{adj}=V_{base}×(1−Σ(C_{penalty}))+V_{upgrades}, where V_{base} represents the baseline market value, C_{penalty} represents the coefficient for each defect identified, and V_{upgrades} represents the added value from any enhancements or premium features. For example, the system may assign penalty coefficient values such as 0.02 for minor scratches, 0.05 for moderate dents, 0.10 for significant mechanical wear, and 0.08 for high mileage deviation from expected values, illustrating how different condition factors are quantified into penalty coefficients. This vector-based approach may enable the system to efficiently process condition adjustments across all vehicles in a defined inventory group while maintaining individualized accuracy for each vehicle's attributes. These condition-based valuation metrics enable systematic adjustment of estimated values across all vehicles in a defined inventory group.

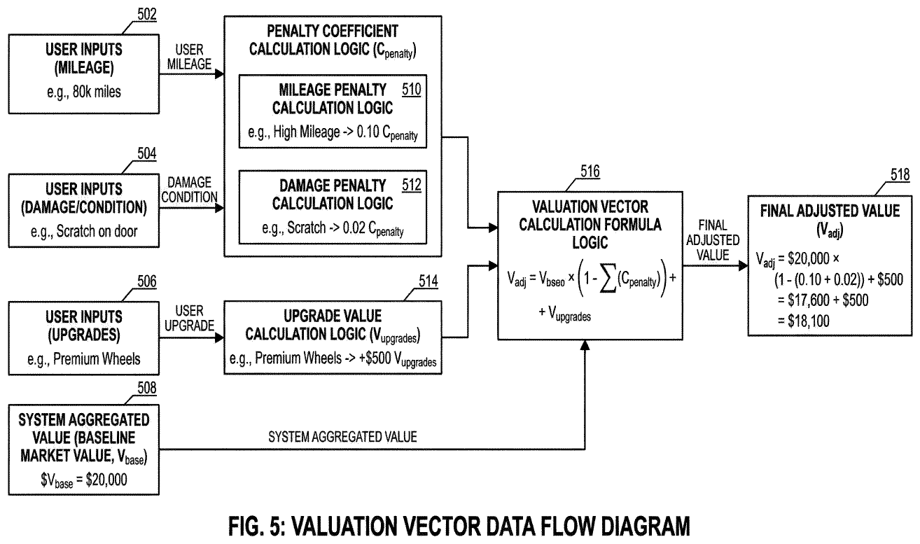

FIG. 5 is a valuation vector data flow diagram illustrating the weighted vector approach for determining a vehicle's specific adjusted value in accordance with embodiments of the present disclosure. The diagram depicts a valuation vector calculation framework that receives inputs from multiple sources to compute a condition-adjusted valuation. A user mileage input 502 provides mileage data such as the vehicle's odometer reading. A user damage condition input 504 provides damage and condition information such as scratches, dents, or mechanical wear indicators. A user upgrades input 506 provides upgrade information such as premium wheels, technology packages, or performance modifications.

A system aggregated baseline value 508 provides the starting valuation derived from the aggregated external data sources, representing the market value before condition-specific adjustments are applied. The user mileage input 502 flows into a mileage penalty calculation logic 510, which converts mileage data into a penalty coefficient. The user damage condition input 504 flows into a damage penalty calculation logic 512, which converts damage conditions into corresponding penalty coefficients. The user upgrades input 506 flows into an upgrade value calculation logic 514, which determines the added value from enhancements.

These calculation logic modules feed into a valuation vector calculation formula logic 516, which processes them along with the system aggregated baseline value 508 to generate a final adjusted value 518.

The valuation vector calculation formula logic 516 performs the internal processing that converts raw condition metrics into penalty coefficients and applies the valuation formula. Condition metrics provided by the user or derived from external sources 302, 304, 306 are transformed into penalty coefficients that quantify the impact of each condition factor on the vehicle's value. For example, a high mileage input of 120,000 miles on a vehicle with an expected mileage of 80,000 miles is converted by the mileage penalty calculation logic 510 into a penalty coefficient of 0.15, representing a 15% deduction from the base value. Similarly, damage indicators such as moderate body damage are converted by the damage penalty calculation logic 512 into corresponding penalty coefficients such as 0.05. The valuation vector calculation formula logic 516 applies the formula: V_{adj}=V_{base}×(1−ΣC_{penalty})+V_{upgrades}, where V_{base} represents the system aggregated baseline value 508, C_{penalty} represents each coefficient calculated by the mileage penalty calculation logic 510 and the damage penalty calculation logic 512, and V_{upgrades} represents the value determined by the upgrade value calculation logic 514 based on the user upgrades input 506. The penalty coefficients reduce the base value multiplicatively through the term (1−ΣC_{penalty}), while the upgrade values add absolute value to the result, reflecting the distinct economic impact of condition deficiencies versus value-adding enhancements. The valuation vector calculation formula logic 516 outputs the final adjusted value 518.

The final adjusted value 518 represents the condition-adjusted valuation for the vehicle after all penalty deductions and upgrade additions have been applied by the valuation vector calculation formula logic 516. The vector-based structure of this calculation architecture enables efficient batch processing of vehicle groups within a defined inventory group. For each vehicle in the group, the system populates the mileage penalty calculation logic 510, the damage penalty calculation logic 512, and the upgrade value calculation logic 514 with vehicle-specific data based on that vehicle's individual condition metrics and enhancements. The valuation vector calculation formula logic 516 applies consistent calculation logic across all vehicles in the defined inventory group, varying the vehicle-specific inputs for each vehicle, thereby supporting the generation of comprehensive valuation reports for the entire defined inventory group.

For users managing multiple vehicles, the system may support the categorization of inventory into defined inventory groups. Vehicles may be grouped based on characteristics such as type, for example, truck, sedan, or compact. These groupings enable streamlined management, allowing users to apply updates or perform analyses across multiple vehicles simultaneously.

The user profile thereby serves as a centralized repository for all relevant vehicle data, providing a foundation for further functionalities such as valuation, market analysis, and fleet optimization. In one embodiment, the profile may include features to track maintenance logs, monitor depreciation, or update vehicle condition dynamically, ensuring that the inventory remains accurate and reflective of current market and operational conditions.

In one example use case, a vehicle rental business managing a fleet of 200 vehicles may utilize the integrated vehicle valuation and management system described herein to optimize operations and profitability. The system may provide a user interface configured to facilitate the bulk upload of vehicle information, such as VINs, make, model, year, condition, mileage, and upgrades, with each vehicle categorized by model, type, and condition for streamlined analysis.

The system may retrieve pricing data from external sources 302, 304, 306, including wholesale platforms, trade-in programs, and new vehicle retail pricing databases, to generate comprehensive valuations. Using this aggregated data, the system may identify underperforming vehicles, such as determining that 50 out of 200 vehicles have depreciated beyond a predetermined threshold and are flagged as candidates for replacement. The system may further analyze market conditions to provide geographic and platform-specific recommendations, such as determining that selling certain vehicles in Region X may yield 15% more profit compared to other platforms due to regional demand trends. The system may also employ machine learning models to predict future trends, such as anticipated seasonal demand for specific vehicle types, enabling the business to make informed decisions and maintain a competitive edge in the vehicle rental industry.

Aspects of the subject matter described herein may take the form of a computer program product embodied in a non-transitory computer readable medium having computer executable program code embodied thereon. A computer readable storage medium may be a tangible medium that can contain, or store a program for use by or in connection with an instruction execution system, apparatus, or device. A computer readable medium may include, but not limited to, an electronic, magnetic, optical, electromagnetic, infrared, or semiconductor system, apparatus, or device, an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or a suitable combination thereof.

The subject matter described herein may be implemented as software-as-a-service (SaaS) that is centrally hosted in the cloud and licensed on a subscription basis. One or more users may communicate with the system over a communications network, such as the Internet. Cloud storage may store or manage information using a public or private cloud where the physical storage spans multiple servers. The subject matter herein may be implemented using machine learning (ML) or other artificial intelligence models. ML uses computer algorithms that can improve automatically using data. Machine learning algorithms build a model based on sample data (training data) to make predictions or decisions without being explicitly programmed to do so. Machine learning-based software may include a model generator, a training data module, a model processor, a model memory, and a communication device. In some embodiments, machine learning-based software may generate decision trees, use association rule mining, artificial neural networks, and/or deep learning algorithms to develop models. In some embodiments, machine learning-based software may utilize hardware optimized for machine learning functions, such as an FPGA or GPU.

The flowchart and block diagrams in the figures may illustrate and/or represent the architecture, functionality, and operation of possible implementations of systems, methods and computer program products according to various embodiments of the subject matter described herein. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although the subject matter described herein has been described and illustrated with a degree of particularity, it is understood that the present disclosure has been made by way of example, and that numerous changes in the combination and arrangement of parts can be resorted to by those skilled in the art without departing from the spirit and scope of the subject matter described herein, as hereinafter claimed.

1. A system for vehicle valuation, comprising:
a batch processing module configured to receive a plurality of vehicle identifiers corresponding to a plurality of vehicles in a defined inventory group;
a processor and memory configured to:
retrieve vehicle information for the plurality of vehicles from a plurality of external sources, wherein the external sources utilize heterogeneous data schemas;
normalize disparate condition metrics from the external sources into a common internal representation using normalization logic comprising at least one mapping structure that associates external metrics with internal normalized values;
perform a conflict resolution operation when multiple external sources provide conflicting values for a same vehicle, the conflict resolution operation comprising identifying outliers according to a statistical dispersion measure and aggregating non-outlier values according to source-specific weights derived from source reliability indicators;
apply condition-based valuation metrics using the common internal representation to determine an adjusted estimated value for each vehicle in the defined inventory group;
generate a valuation report comprising at least the adjusted estimated value of each vehicle in the defined inventory group; and
a user interface configured to present the valuation report.

2. The system of claim 1, wherein the valuation report further comprises a disposition timing recommendation for at least one vehicle based on projected values and market trends.

3. The system of claim 2, wherein the disposition timing recommendation comprises a sell indicator, a hold indicator, or an acquire indicator for each vehicle based on comparing current adjusted estimated values against projected future values.

4. The system of claim 1, wherein the mapping structure comprises an equivalence threshold matrix storing mappings between external grading schemas and values on a unified grading scale.

5. The system of claim 1, wherein the normalization logic comprises a learned mapping model trained to convert external grading schemas into internal normalized values based on historical data correlating external source outputs with actual transaction outcomes.

6. The system of claim 1, wherein the statistical dispersion measure comprises an interquartile range, and wherein the processor is configured to flag external sources whose estimated values fall outside 1.5 times the interquartile range as statistical outliers.

7. The system of claim 1, wherein the source reliability indicators comprise historical accuracy, data freshness, and source specificity, and wherein the processor is configured to compute a composite reliability score for each external source as a weighted sum of the historical accuracy, the data freshness, and the source specificity.

8. The system of claim 1, wherein the processor is further configured to maintain a source-vehicle-affinity matrix that stores reliability scores on a per-source-per-vehicle-type basis, and wherein during the conflict resolution operation the processor retrieves a vehicle type category for a vehicle being valued and applies a source-specific reliability score for the vehicle type category as a weighting factor.

9. The system of claim 1, wherein the processor is further configured to compute a market volatility index for a vehicle segment by analyzing a standard deviation of price changes observed across transactions within the vehicle segment, and to apply the market volatility index as a multiplier to a time-based freshness degradation rate when computing a freshness component of the source reliability indicators.

10. The system of claim 1, wherein the batch processing module is further configured to perform asynchronous API polling of the external sources to retrieve vehicle information for the plurality of vehicles concurrently, wherein the asynchronous API polling comprises transmitting concurrent request signals to the external sources and aggregating responses via callback handlers as the responses arrive.

11. A computer-implemented method comprising:
receiving, via a batch processing module, a plurality of vehicle identifiers corresponding to a plurality of vehicles in a defined inventory group;
asynchronously retrieving vehicle information for the plurality of vehicles from a plurality of external sources using non-blocking requests, wherein the external sources utilize heterogeneous data schemas;
normalizing disparate condition metrics from the external sources into a common internal representation using at least one of a lookup matrix or a learned mapping model;
performing a conflict resolution operation when multiple external sources provide conflicting values for a same vehicle, the conflict resolution operation comprising detecting anomalous values and aggregating remaining values using weights derived from source reliability indicators;
applying condition-based valuation metrics using the common internal representation to adjust estimated values for each vehicle in the defined inventory group;
generating a valuation report comprising at least an adjusted estimated value of each vehicle in the defined inventory group; and
presenting the valuation report via a user interface.

12. The method of claim 11, wherein the valuation report further comprises a disposition timing recommendation for at least one vehicle based on projected values and market trends.

13. The method of claim 11, wherein normalizing disparate condition metrics comprises mapping external condition grades from the external sources to a unified grading scale using an equivalence threshold matrix, wherein the external condition grades include at least one of numerical grades or categorical grades.

14. The method of claim 11, wherein detecting anomalous values comprises computing an interquartile range of estimated values received from the external sources and flagging sources whose estimated values fall outside a dynamic threshold based on the interquartile range.

15. The method of claim 11, wherein the source reliability indicators comprise at least one of historical accuracy, data freshness, source specificity, or data completeness.

16. The method of claim 11, further comprising applying reliability score degradation to external sources that are repeatedly flagged as providing anomalous values, wherein the reliability score degradation reduces a source-specific weight applied during subsequent conflict resolution operations.

17. A non-transitory computer-readable storage medium storing instructions that, when executed by a processor, cause the processor to:
receive, via a batch processing module, a plurality of vehicle identifiers corresponding to a plurality of vehicles in a defined inventory group;
retrieve vehicle information for the plurality of vehicles from a plurality of external sources utilizing heterogeneous data schemas;
normalize disparate condition metrics from the external sources into a common internal representation using normalization logic;
perform a conflict resolution operation comprising identifying outliers and aggregating non-outlier values according to source-specific weights;
apply condition-based valuation metrics using the common internal representation to adjust estimated values for each vehicle in the defined inventory group;
generate a valuation report comprising at least an adjusted estimated value of each vehicle in the defined inventory group; and
present the valuation report via a user interface.

18. The non-transitory computer-readable storage medium of claim 17, wherein the valuation report further comprises a disposition timing recommendation for at least one vehicle based on projected values and market trends.

19. The non-transitory computer-readable storage medium of claim 17, wherein the normalization logic comprises at least one of an equivalence threshold matrix or a learned mapping model trained on historical data.

20. The non-transitory computer-readable storage medium of claim 17, wherein the instructions further cause the processor to maintain a source-vehicle-affinity matrix that stores reliability scores on a per-source-per-vehicle-type basis, and wherein during the conflict resolution operation the processor queries the source-vehicle-affinity matrix to obtain a source-specific reliability score for a vehicle type category of a vehicle being valued.
